(19) United States
(12) Patent Application Publication
(10) Pub. No.: US 2009/0060629 A1
(43) Pub. Date: Mar. 5, 2009

(54) Portable and hangable document file folder

(76) Inventor: Chun Yuan Chang, Taipei (TW)

Correspondence Address: Chun Yuan Chang, P.O. Box 44-2049, Taipei, TW

(21) Appl. No.: 11/892,993

(22) Filed: Aug. 29, 2007

(51) Int. Cl. B42F 13/40

(52) U.S. Cl. 402/4

(57) ABSTRACT

A portable and hangable document file folder, which is an improvement to a typical stationery folder that is placed and kept stationary. The folder has hidden handles and a hidden hang rod that may be hung, an integrally formed elastic holding plate for clamping sheets to be written, and a movable cover piece disposed on a side surface of the folder to cover a removable sheet. Thus, the folder may be placed or hung, may be carried out and provide a platen for the momentary writing and recording so that a multi-function document file folder is provided.

### BACKGROUND OF THE INVENTION

(1) Field of the Invention

The invention relates to a document file folder, and more particularly to a portable and hangable document file folder improved from a conventional stationery folder, which may be opened to accommodate documents or stationery, so that the document file folder may satisfy the user's requirements in the aspects of being placed or used, and a multi-function document file folder may be obtained.

(2) Description of the Prior Art

A user may place sheets or stationery in a typical stationery folder, which may be used by the user in a stationary manner. The conventional stationery folder is frequently placed on a desk or rests against a bookshelf so that the user can easily take and use the folder when he or she is working in the office. In other words, if this kind of stationery folder is designed to have the function approximating the user's requirement or to be used more widely, the will of the consumer of purchasing the product may be influenced.

FIG. 6 is a schematic illustration showing a structure of a conventional stationery folder. As shown in FIG. 6, a conventional stationery folder 50 has a simple rectangular shape, and no device for clamping documents or sheets is provided on a front side of an upper cover 51. The upper cover 51 and a lower cover 52 are combined together only through a fastener 53. Also, in practice, when the user takes out the document, he or she cannot read and write the document immediately but has to find a suitable platen on which the document is written, or has to hold the document by his hand. Thus, the document cannot be conveniently used and read. In addition, the documents may be blown away or lost, thereby causing the unnecessary loss. Although the conventional stationery folder 50 can conveniently accommodate the sheets and the stationery, it is not designed according to the consideration that the user needs to write on the stationery folder 50 or the consideration that the sheets or documents have to be clamped to facilitate the reading. Thus, the conventional product still has to be improved.

FIG. 7 shows an application of the conventional stationery folders. As shown in FIG. 7, the internal structure of the conventional stationery folder only has the space for accommodating a sheet 55 and a pen 54 or other stationery, and the stationery folder 50 has no portable device or handle to make the stationery folder 50 be easily carried outside. In practice, the stationery folder 50 is only limited to the usage of the stationary condition. So, the stationery folder 50 often appears in the office, such as on a desk 56 or on a bookshelf 57, and its utility is restricted because the conventional stationery folder 50 has no handle. Thus, the stationery folder 50 cannot be widely used, and this drawback that the folder cannot be carried outside needs to be solved.

However, the current stationery folder is designed without considering the functions that the folder can be easily collected and carried outside. As for the consumer, the actual use convenience is restricted by the problems that the folder cannot be easily collected and carried outside, thereby losing the desired functions of the stationery folder.

### SUMMARY OF THE INVENTION

In view of the associated problems induced by the design defects of the conventional stationery folder, the present inventor has paid attention to the research and development according to the experience and the technology in manufacturing the associated products for many years, and thus developed this portable and hangable document file folder. The main object is to add a set of handles to an upper cover and a lower cover of the file folder so that the handles may be smoothly placed into chambers of the file folder, or may be lifted up to be carried by the user conveniently, thereby greatly improving the drawback that the conventional file folder cannot be conveniently carried. In addition, multiple file folders may be simultaneously hoarded or collected because no exposed handle will occupy any space. Thus, the utility and the convenience of the file folder can further be enhanced.

Another object of the invention is to add an elastic holding plate to a surface of the file folder, wherein the elastic holding plate is integrally formed with a front side of the file folder so that it can simultaneously clamp a pen and documents. When the user is writing or recording data on the file folder, he or she does not have to worry about that the pen will lost or the pen cannot be found. In addition, the elastic holding plate is configured to clamp the documents or sheets tightly so that the user can read the documents on the upper cover of the file folder more conveniently.

Still another object of the invention is to add a hang rod to the file folder so that the file folder may be hung or placed on a handcart and the user can conveniently manage the transportation and distribution of a whole batch of file folders and effectively improve the drawback of the messy stack of the file folders. Also, the file folders may be orderly hung so that the user may take and place the folders conveniently and the time for finding and managing the folder may be effectively shortened.

Yet still another object of the invention is to add a movable cover piece to a side cover of the file folder. After the movable cover piece is removed, a sheet for recording the message about contents of the file folder may be sandwiched between the movable cover piece and the side cover so that the user may conveniently find and collect the file folders. In addition, the movable cover piece has engaging blocks for engaging with grooves of the side cover so that the movable cover piece may be quickly assembled and disassembled practically.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic illustration showing a structure of the invention.

FIG. 2 is a schematic illustration showing an internal structure of the invention.

FIG. 3 is a schematic illustration showing a structure of a movable cover piece of the invention.

FIG. 4 is a schematic illustration showing an operation of pulling a hang rod according to the invention.

FIG. 5 shows an embodiment of the invention.

FIG. 6 is a schematic illustration showing a structure of a conventional stationery folder.

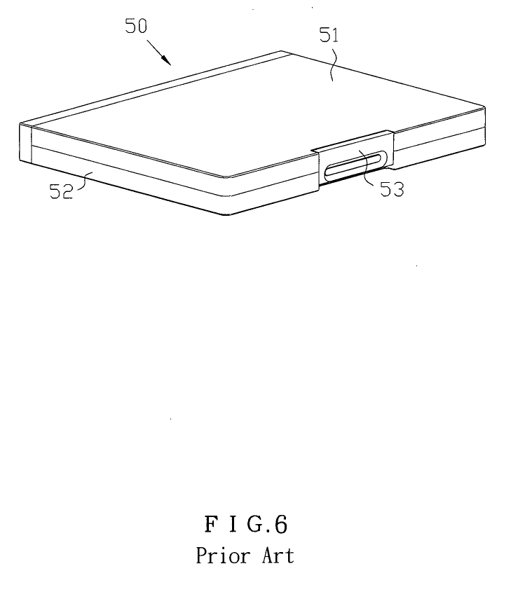

FIG. 7 shows an application of the conventional stationery folders.

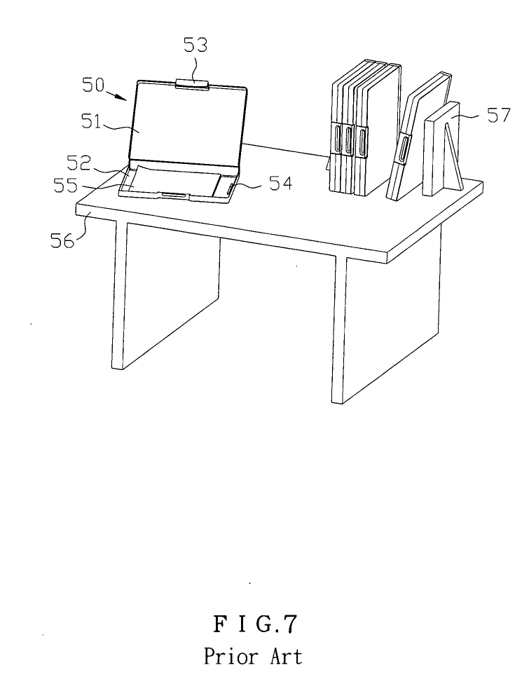

### DETAILED DESCRIPTION OF THE PREFERRED EMBODIMENTS

The structure, technological means and effects of the invention will be described with reference to the preferred embodiment in conjunction with the accompanying drawings.

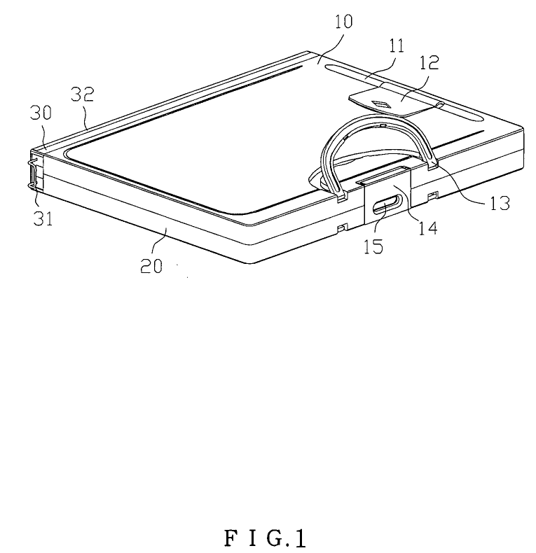

FIG. 1 is a schematic illustration showing a structure of the invention. Referring first to FIG. 1, the folder of the invention is mainly composed of an upper cover 10, a lower cover 20 and a side cover 30. Handles 13 are smoothly placed in chambers formed on the upper cover 10 and the lower cover 20, respectively, or may be lifted to be carried by the user. In addition, a fastener 14 is disposed on a lateral side of the upper cover 10 and functions to engage with an engaging protrusion 15 of the lower cover 20 so that the lower cover 20 and the upper cover 10 may be combined together more tightly. Also, the upper cover 10 is formed with a pen recess 11 and an elastic holding plate 12. The one-piece molded elastic holding plate 12 can be used to clamp a pen and sheets simultaneously to prevent the user from worrying about that the pen will be lost or cannot be found when he or she is writing on the upper cover 10. The elastic holding plate 12 is designed to tightly clamp the documents or the sheets so that the user can write or read on the file folder conveniently and the utility and the convenience thereof may be greatly enhanced.

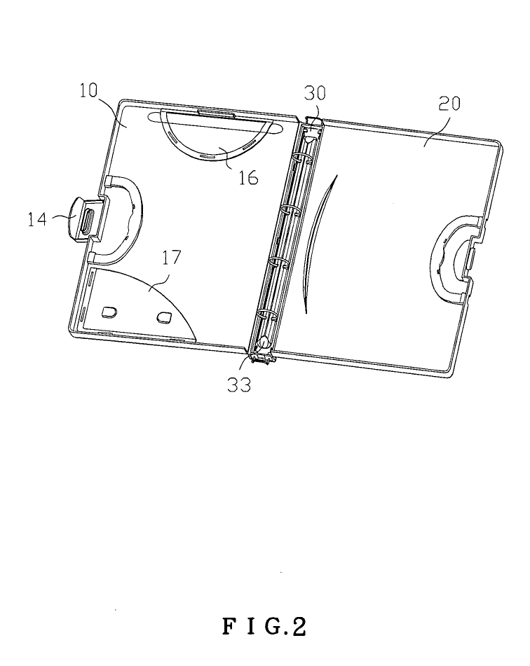

FIG. 2 is a schematic illustration showing an internal structure of the invention. As shown in FIG. 2, the other surface of the upper cover 10 is provided with a structure reinforcement piece 16, which functions to reinforce the intensity of the elastic holding plate 12 and to prevent the elastic holding plate 12 from breaking due to the frequent use of clamping the documents. Also, a sheet may be clipped by a clipping piece 17 in the file folder so that the functionality of the invention is enhanced. In addition, a bookbinder 33 is attached into the side cover 30 so that the user may conveniently place and take the sheet, it is possible to prevent the important document from being lost when the file folder is carried out, and the file folder may have the better accommodating ability and the better utility.

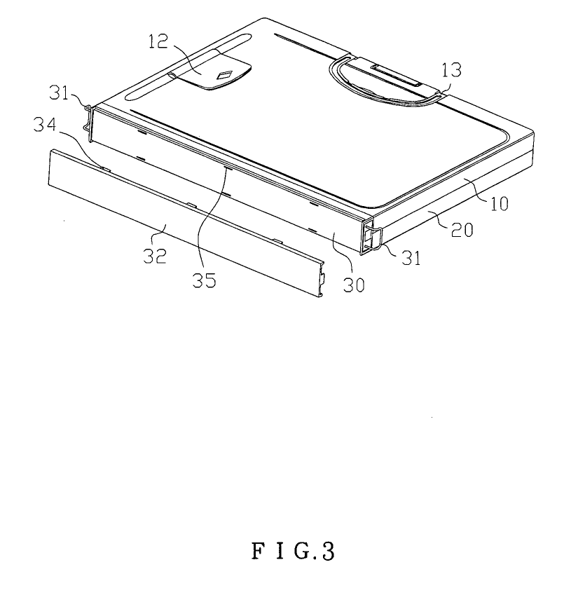

FIG. 3 is a schematic illustration showing a structure of a movable cover piece of the invention. Furthermore, as shown in FIG. 3, a movable cover piece 32 is attached to one side of the side cover 30 and mainly functions to clip a sheet between the movable cover piece 32 and the side cover 30 so that the user can find and collect the file folders. The movable cover piece 32 has engaging blocks 34 for engaging with grooves 35 so that the movable cover piece 32 may be quickly disassembled. The movable cover piece 32 is removably attached to an external side surface of the folder through several sets of engaging blocks 34.

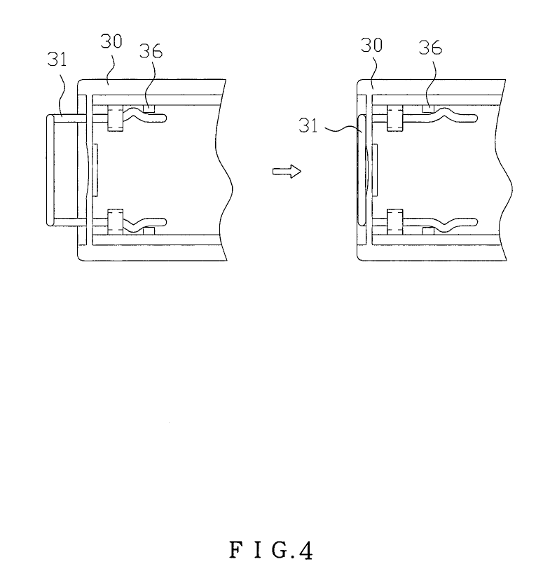

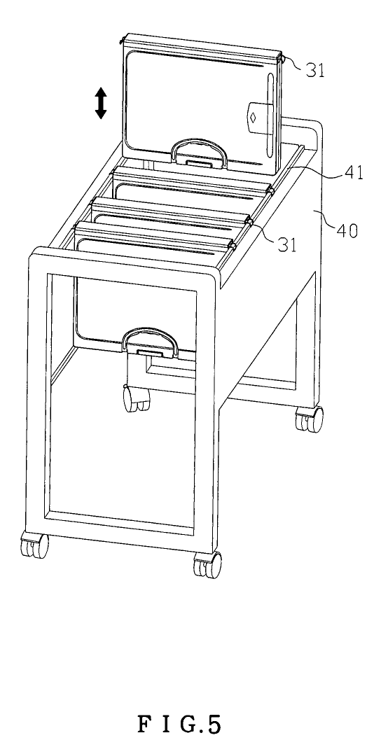

FIG. 4 is a schematic illustration showing an operation of pulling a hang rod according to the invention. FIG. 5 shows an embodiment of the invention. As shown in FIG. 4, a hang rod 31 may extend into the side cover 30, and then tightly press against the side cover 30 through engaging projections 36. When the user needs to hang the file folder, he or she can pull out the hang rod 31 by a predetermined length. When the file folder is to be carried out, the hang rod 31 is hidden into the side cover 30 to prevent the hang rod 31 from exposing to the outside and thus from colliding with or hooking other objects. In addition, as shown in FIG. 5, the hang rod 31 of the file folder may be hung on a side rib 41 of a handcart 40 so that the user can conveniently manage the transportation and distribution of a whole batch of file folders and effectively improve the drawback of the messy stack of the file folders.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A portable and hangable document file folder, mainly comprising:
a set of handles disposed on an upper cover and a lower cover of the file folder and disposed opposite to each other, wherein the handles may be smoothly placed in chambers formed on the upper cover and the lower cover and may be lifted out of the chambers and thus to be carried;
a hang rod disposed on two lateral sides of a side cover of the file folder, wherein the hang rod may be hidden into the side cover and tightly presses against the side cover by engaging projections; and
a movable cover piece removably attached to an external side surface of the folder through several sets of engaging blocks.

2. The portable and hangable document file folder according to claim 1, wherein the hang rod may be pulled out by a predetermined length so that the folder may be hung.
